(19) United States
(12) Patent Application Publication
(10) Pub. No.: US 2014/0175049 A1
(43) Pub. Date: Jun. 26, 2014

(54) PRE-PATTERNED FILM-BASED RESIST

(71) Applicant: APPLE INC., Cupertino, CA (US)

(72) Inventors: Siddharth MOHAPATRA, Santa Clara, CA (US); Sunggu KANG, San Jose, CA (US); John Z. ZHONG, Cupertino, CA (US)

(73) Assignee: Apple Inc., Cupertino, CA (US)

(21) Appl. No.: 13/724,948

(22) Filed: Dec. 21, 2012

(51) Int. Cl. H01H 11/00

(52) U.S. Cl. CPC H01H 11/00
USPC 216/20; 156/60; 156/256; 216/13; 156/275.5

(57) ABSTRACT

Roll-to-roll processes for manufacturing touch sensors using a sheet of patterned photoresist film are disclosed. The photoresist film can include a sheet of photoresist material, such as DFR, that has been patterned by removing portions of the photoresist film using a die or laser cutting technique. In some examples, the photoresist film can be patterned such that the patterned photoresist film can be laminated to a base film and used as an etching mask or a photoresist layer in a roll-to-roll manufacturing process. In this way, the patterned photoresist film can be used in place of conventional photoresist films in roll-to-roll processes, thereby obviating the need for subsequent exposure and development operations that would otherwise be performed when using conventional photoresist films. As a result, the chance that a defect is introduced into the touch sensors is reduced by reducing the number of operations performed in the roll-to-roll process.

### FIELD

This relates generally to touch sensors and, more specifically, to manufacturing touch sensors using patterned sheets of photoresist.

### BACKGROUND

Many types of input devices are presently available for performing operations in a computing system, such as buttons or keys, mice, trackballs, joysticks, touch sensor panels, touch screens, and the like. Touch sensitive devices, such as touch screens, in particular, are becoming increasingly popular because of their ease and versatility of operation. A touch sensitive device can include a touch sensor panel, which can include a dear panel with a touch-sensitive surface, and a display device, such as a liquid crystal display (LCD) or organic light emitting diode (OLED) display, that can be positioned partially or fully behind the panel so that the touch-sensitive surface can cover at least a portion of the viewable area of the display device. The touch sensitive device can allow a user to perform various functions by touching the touch sensor panel using a finger, stylus, or other object at a location often dictated by a user interface (UI) being displayed by the display device. In general, the touch sensitive device can recognize a touch event and the position of the touch event on the touch sensor panel, and the computing system can then interpret the touch event in accordance with the display appearing at the time of the touch event, and thereafter can perform one or more actions based on the touch event,

Many processes have been developed to manufacture these touch sensors. For example, conventional roll-to-roil processes involve patterning electronic devices onto rolls of thin, flexible plastic or metal foil and removing these devices from the roll using lithography or a physical cutting process. In this way, large batches of devices can be produced quickly and economically. However, like other manufacturing methods, these roll-to-roll processes are susceptible to yield loss due to manufacturing defects in the devices. This is at least partially due to the numerous steps involved in the roll-to-roll processes, as each step has an associated chance of causing defects in the devices. Thus, improved roll-to-roll processes are desired.

### SUMMARY

This relates to roll-to-roll processes for manufacturing touch sensors using a sheet of patterned photoresist film. In some examples, the photoresist film can include a sheet of photoresist material, such as dry film resist (DFR) that has been patterned by selectively removing portions of the photoresist film using any of various die cutting or laser cutting techniques. In some examples, the photoresist film can be patterned in a way such that the patterned photoresist film can be laminated to a base film and used as an etching mask or a passivation layer in a roll-to-roll manufacturing process. In this way, the patterned photoresist film can be used in place of conventional photoresist films in roll-to-roll processes, thereby obviating the need for subsequent exposure and development operations that would otherwise be performed when using the conventional photoresist films. As a result, the chance that a defect is introduced into the touch sensors is reduced by reducing the number of operations that must be performed in the roll-to-roll process.

### BRIEF DESCRIPTION OF THE DRAWINGS

FIG, 1 illustrates an exemplary touch sensor according to various examples.

FIG. 2 illustrates atop view of an exemplary touch sensor according to various examples.

FIG. 3 illustrates an exemplary process for manufacturing a touch sensor according to various examples.

FIGS. 4-11 illustrate a touch sensor at various stages of manufacture according to various examples.

FIG. 12 illustrates a pre-patterned photoresist film according to various examples.

FIG. 13 illustrates an exemplary process for manufacturing a touch sensor using a patterned photoresist film according to various examples.

FIG. 14 illustrates an exemplary mother sheet containing multiple touch sensors according to various examples.

FIG. 15 illustrates an exemplary system for manufacturing a touch sensor using a patterned sheet of photoresist film according to various examples.

FIGS. 16-19 illustrate exemplary personal devices having a touch sensor manufactured using sheets of patterned photoresist film according to various examples.

### DETAILED DESCRIPTION

In the following description of the disclosure and examples, reference is made to the accompanying drawings in which it is shown by way of illustration specific examples that can be practiced. It is to be understood that other examples can be practiced and structural changes can be made without departing from the scope of the disclosure.

This relates to roll-to-roll processes for manufacturing touch sensors using a sheet of patterned photoresist film. In some examples, the photoresist film can include a sheet of photoresist material, such as DFR, that has been patterned by selectively removing portions of the photoresist film using any of various die cutting, laser cutting, or other cutting techniques. In some examples, the photoresist film can be patterned in a way such that the patterned photoresist film can be laminated to a base film and used as an etching mask or a passivation layer in a roll-to-roll manufacturing process. In this way, the patterned photoresist film can be used in place of conventional photoresist films in roll-to-roll processes, thereby obviating the need for subsequent exposure and development operations that would otherwise be performed when using the conventional photoresist films. As a result, the chance that a defect is introduced into the touch sensors is reduced by reducing the number of operations that must be performed in the roll-to-roll process.

FIG. 1 illustrates touch sensor 100 that can be used to detect touch events on a touch sensitive device, such as a mobile phone, tablet, touchpad, portable computer, portable media player, or the like. Touch sensor 100 can include an array of touch regions or nodes 105 that can be formed at the crossing points between rows of drive lines 101 (D0-D3) and columns of sense lines 103 (S0-S4). Each touch region 105 can have an associated mutual capacitance Csig 111 formed between the crossing drive lines 101 and sense lines 103 when the drive lines are stimulated. The drive :lines 101 can be stimulated by stimulation signals 107 provided by drive circuitry (not shown) and can include an alternating current (AC) waveform. The sense lines 103 can transmit touch signals 109 indicative of a touch at the touch sensor 100 to sense circuitry (not shown), which can include a sense amplifier for each sense line, or a fewer number of sense amplifiers that can be multiplexed to connect to a larger number of sense lines.

To sense a touch at the touch sensor 100, drive lines 101 can be stimulated by the stimulation signals 107 to capacitively couple with the crossing sense lines 103, thereby forming a capacitive path for coupling charge from the drive lines 101 to the sense lines 103. The crossing sense lines 103 can output touch signals 109, representing the coupled charge or current. When an object, such as a stylus, finger, etc., touches the touch sensor 100, the object can cause the capacitance Csig 111 to reduce by an amount ΔCsig at the touch location. This capacitance change ΔCsig can be caused by charge or current from the stimulated drive line 101 being shunted through the touching object to ground rather than being coupled to the crossing sense line 103 at the touch location. The touch signals 109 representative of the capacitance change ΔCsig can be transmitted by the sense lines 103 to the sense circuitry for processing. The touch signals 109 can indicate the touch region where the touch occurred and the amount of touch that occurred at that touch region location.

While the example shown in FIG. 1 includes four drive lines 101 and five sense lines 103, it should be appreciated that touch sensor 100 can include any number of drive lines 101 and any number of sense lines 103 to form the desired number and pattern of touch regions 105. Additionally, while the drive lines 101 and sense lines 103 are shown in FIG, 11 in a crossing configuration, it should be appreciated that other configurations are also possible to form the desired touch region pattern. While FIG. 1 illustrates mutual capacitance touch sensing, other touch sensing technologies may also be used in conjunction with examples of the disclosure, such as self-capacitance touch sensing, resistive touch sensing, projection scan touch sensing, and the like. Furthermore, while various examples describe a sensed touch, it should be appreciated that the touch sensor 100 can also sense a hovering object and generate hover signals therefrom.

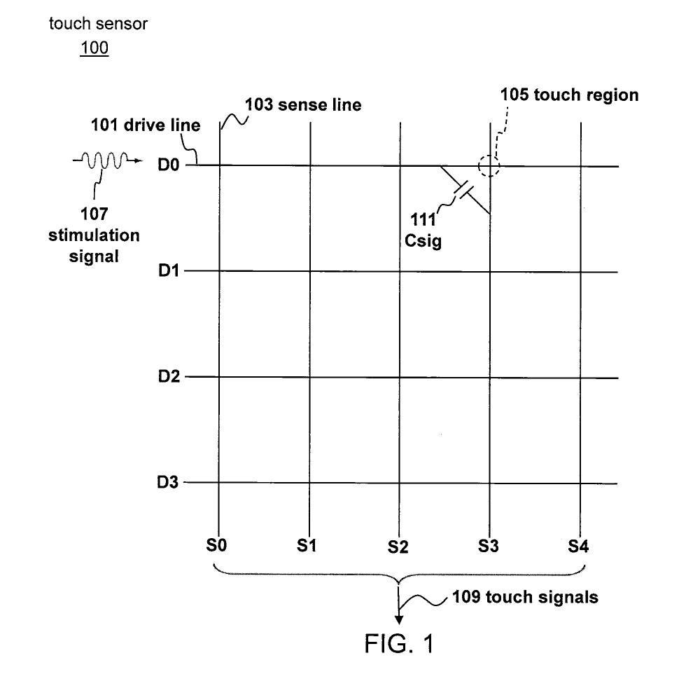

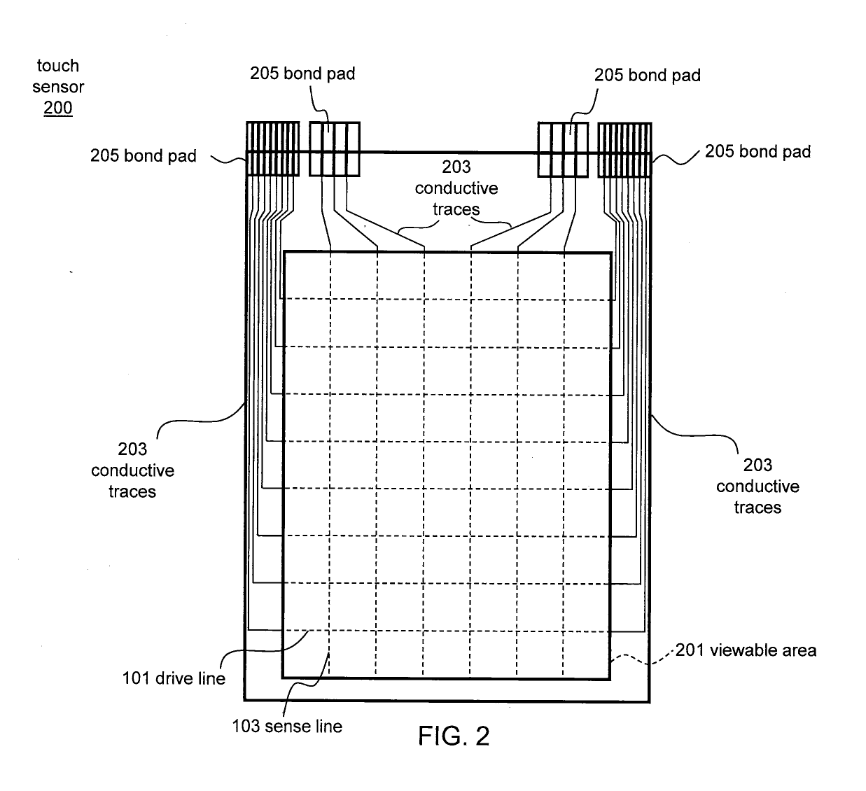

FIG. 2 illustrates a top-view of exemplary touch sensor 200 that can be incorporated within a device, such as a touch sensitive phone, portable media player, tablet computer, or the like. For purposes of explanation, drive lines 101 and sense lines 103 (represented by the dashed lines) are shown in the viewable area 201 of touch sensor 200. However, it should be appreciated that drive lines 101 and sense lines 103 can be made from transparent, or at least substantially transparent, materials, such as indium tin oxide (ITO), silicon oxide, other transparent oxides, or the like. As such, drive lines 101 and sense lines 103 may not be visible to the user.

Touch sensor 200 can include conductive traces 203 (represented by the solid lines) for coupling drive lines 101 and sense lines 103 to bond pads 205. Bond pads 205 can be used to couple drive lines 101 and sense lines 103 to circuitry for driving drive lines 101 and circuitry for interpreting touch signals from sense lines 103. In some examples, conductive traces 203 can be made from a non-transparent material, such as copper or other metals.

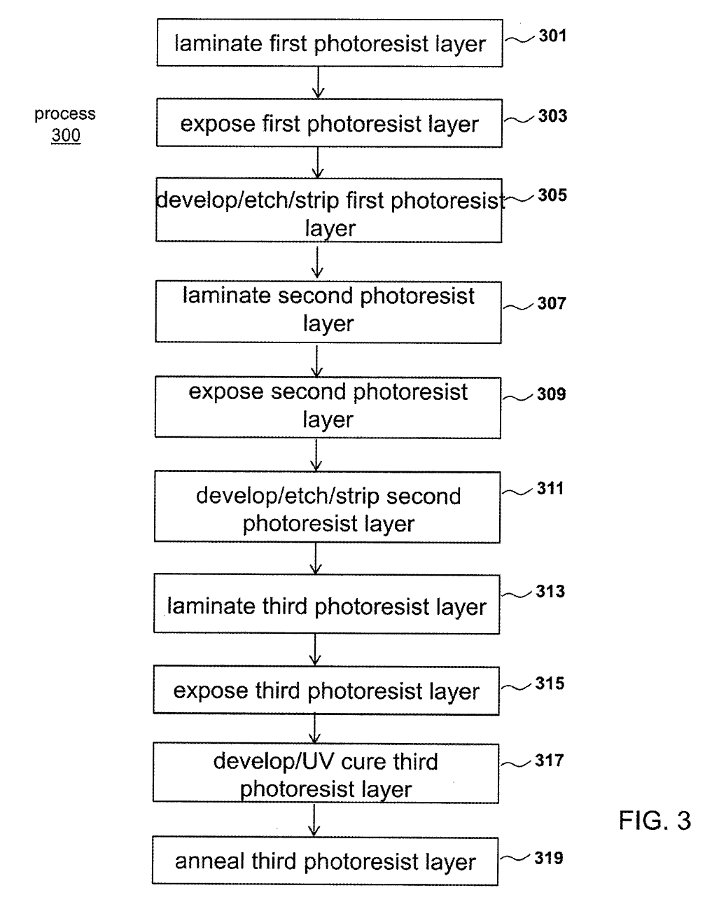

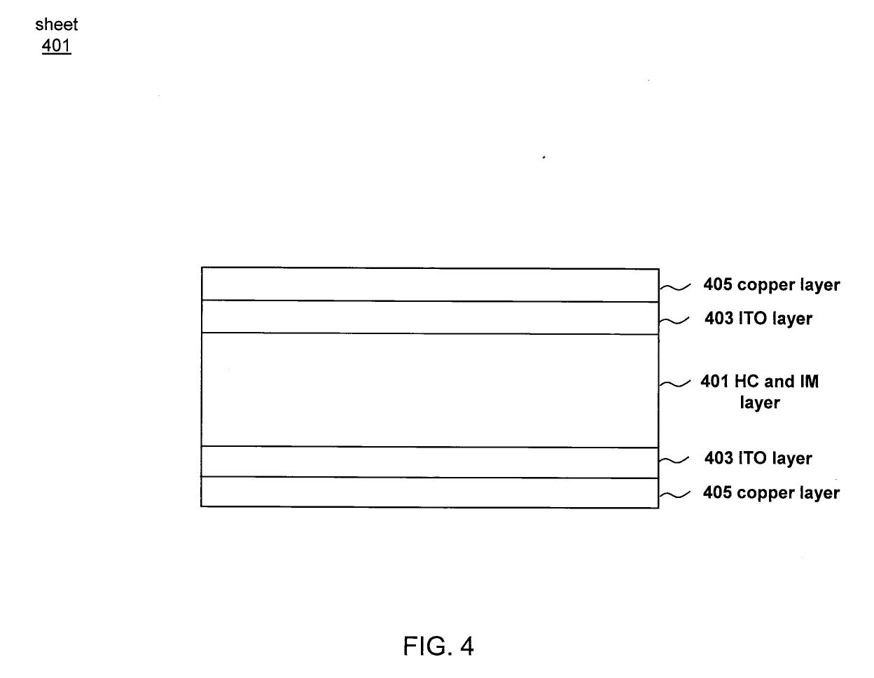

As discussed above, touch sensors, such as touch sensors 100 and 200, and touch sensitive devices can be manufactured using roil-to-roll processes. However, like other manufacturing methods, these roll-to-roll processes are susceptible to yield loss due to manufacturing defects. This can be at least partially due to the numerous steps involved in conventional roll-to-roll processes, as each step has an associated chance of causing a defect in the devices. For example, FIG. 3 illustrates one exemplary roll-to-roll process 300 that can be used to manufacture touch sensors, such as touch sensors 100 and 200, and other touch sensitive electronic devices. Process 300 will be described below with reference to FIGS. 4-11, which illustrate a touch sensor at various stages of manufacture.

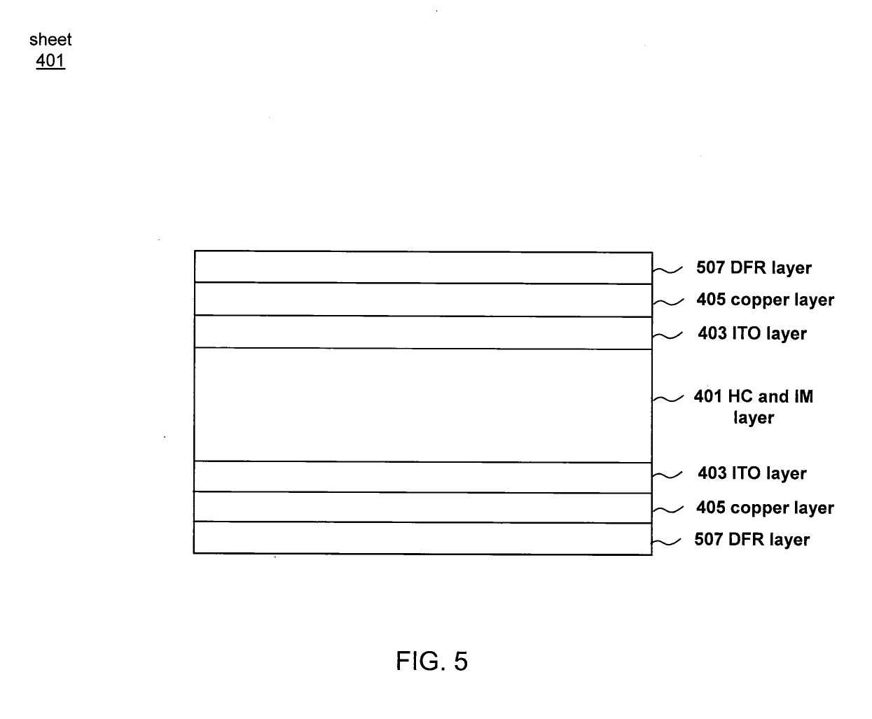

At block 301 of process 300, a first photoresist layer (e.g., a DFR layer) can be laminated onto a substrate, such as a base film. In some examples, as shown in FIG. 4, the sheet of base film 401 can include a flexible plastic material, such as cyclo olefin polymer (COP). In this example, the sheet of base film 401 can include a hard-coat (HC) layer, index matching (IM) layer, indium tin oxide (ITO) layer 403, and copper layer 405. The HC layer and IM layer have been combined into a single HC and IM layer 401 for simplicity, but it should be appreciated that these layers can be separate layers. FIG. 5 illustrates base film 4011 after laminating first DFR layer 507 onto the base film 401 at block 301 of process 300.

At block 303 of process 300, the first photoresist layer can be exposed using known exposure techniques to form a desired pattern in the photoresist layer. For example, first DFR layer 507, as shown in FIG. 5, can be exposed using known exposure techniques to form a desired pattern in the DFR layer.

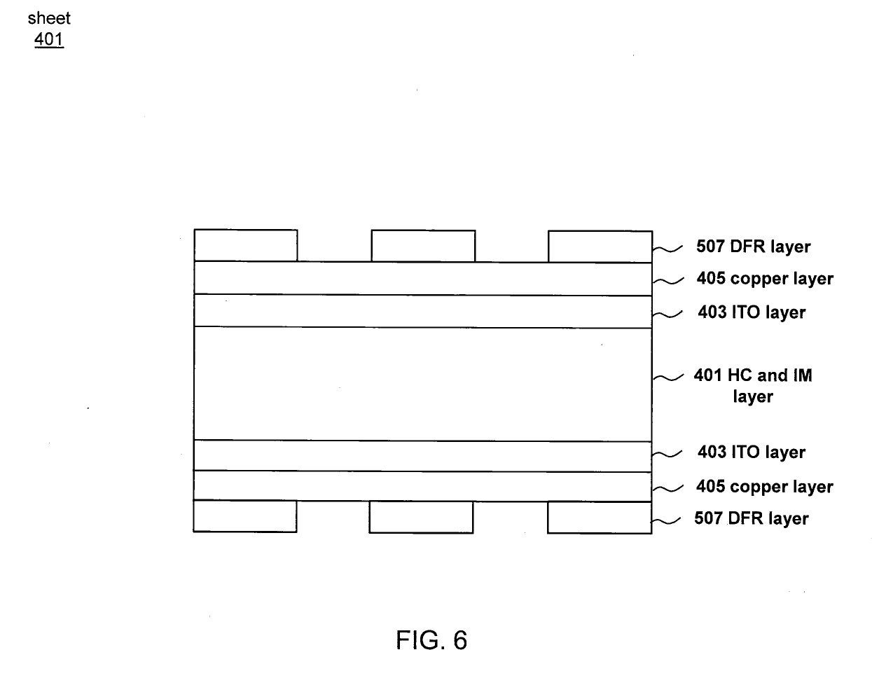

At block 305 of process 300, the first photoresist layer can be developed to remove portions of the photoresist layer based on the pattern formed in the photoresist layer at block 303. The resulting patterned photoresist layer can be used as a mask in a subsequent etching step. For example, as shown in FIG. 6, portions of first DFR layer 507 can be removed at block 305, thereby exposing portions of the underlying copper layer 405. In some examples, the pattern formed in first DFR layer 507 at block 303 (and thus the pattern formed in first DFR layer 507 at block 305) can be used to define the conductive traces, drive lines, sense lines, and bond pads of a touch sensor, such as touch sensor 200. For example, portions of first DFR layer 507 above drive lines 101, sense lines 103, conductive traces 203, and bond pads 205 can be left intact while the remaining portions of the DFR layer 507 can be removed to define drive lines 101, sense lines 103, conductive traces 203, and bond pads 205.

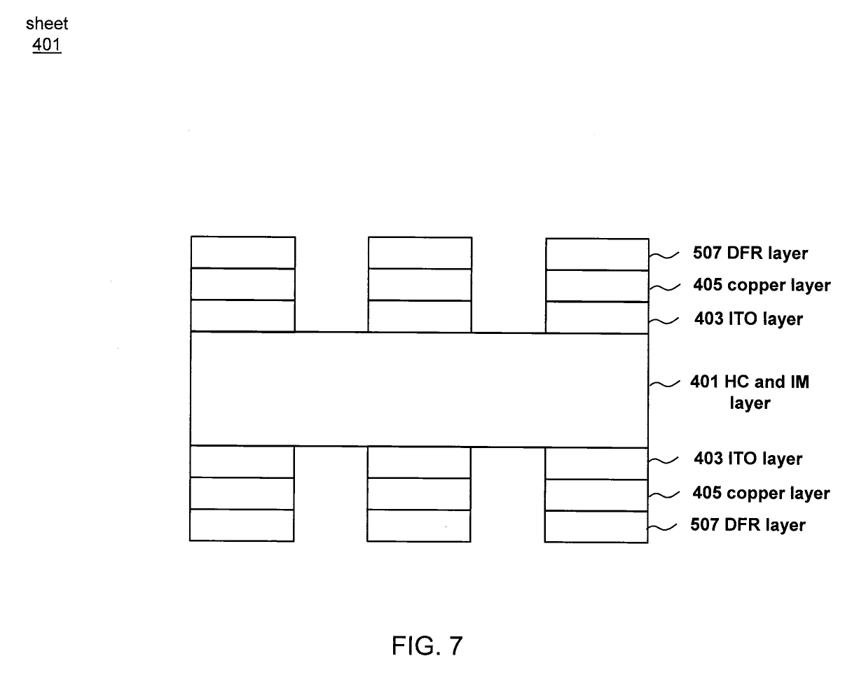

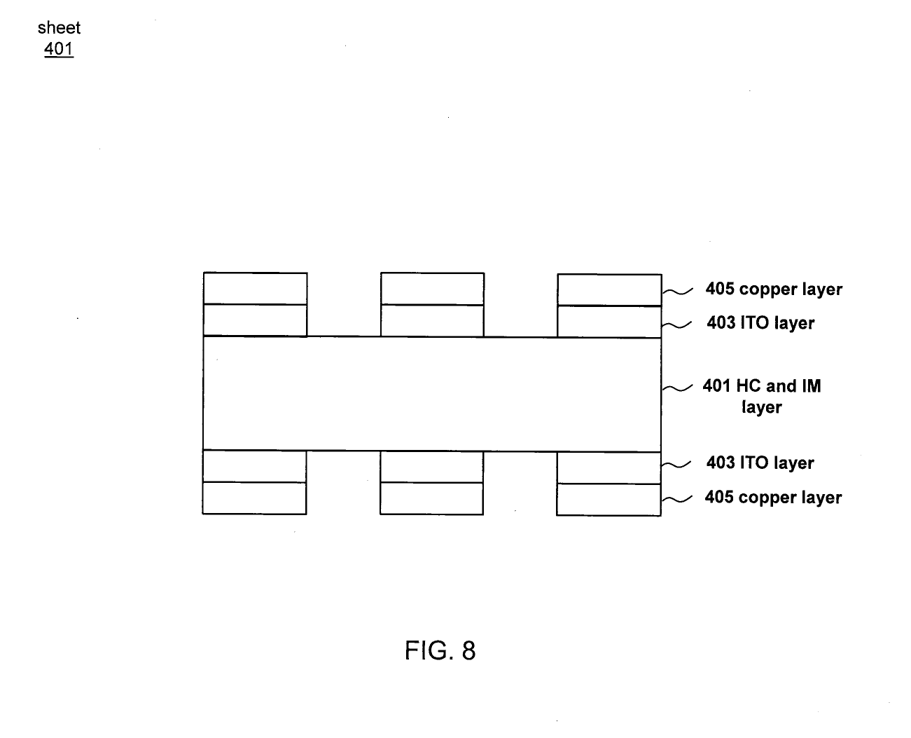

Additionally, at block 305 of process 300, portions of the base film can be etched using the first photoresist layer as a mask. For example, as shown in FIG. 7, the remaining portions of first DFR layer 507 can be used as a mask to selectively etch portions of copper layer 405 and ITO layer 403 using an appropriate etchant. After etching away desired portions of the base film, the remaining portions of the first photoresist layer can be stripped away using known techniques. For example, as shown in FIG. 8, the remaining portions of first DFR layer 507 can be removed, leaving behind the patterned ITO and copper layers 403 and 405.

At block 307 of process 300, a second photoresist layer (e.g., a DFR layer) can be laminated onto the base film. The second photoresist layer can be laminated onto the base film in a manner similar or identical to that performed at block 301 of process 300.

At block 309 of process 300, the second photoresist layer can be exposed using known exposure techniques to form a desired pattern in the photoresist layer in a manner similar to that described above with respect to block 303.

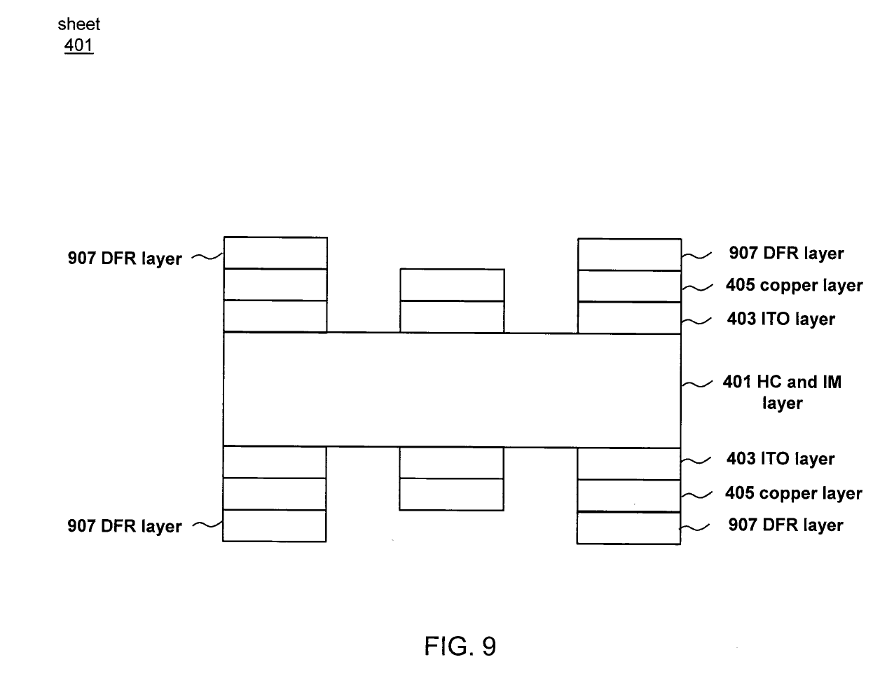

At block 311 of process 300, the second photoresist layer can be developed to remove portions of the photoresist layer based on the pattern formed in the photoresist layer at block 309. Similar to block 305, the resulting patterned photoresist layer can be used as a mask in a subsequent etching step. However, unlike the exposure and development of the first photoresist layer performed at blocks 303 and 305, the second photoresist layer can be exposed and developed such that it can be used as a mask to selectively remove portions of the base film in an area corresponding to the viewable area of a device. For example, as shown in FIG. 9, a second DFR layer 907 can be laminated, exposed, and developed to pattern the DFR layer 907 by removing portions of the second DFR layer 907 located away from the conductive traces and bond pads of the device. In this example, the pattern formed in second DFR layer 907 can be used to remove the portions of copper layer 405 corresponding to viewable area 201 of a touch sensitive device. For example, portions of second DFR layer 907 above conductive traces 203 and bond pads 205 can be left intact while the remaining portions of second DFR layer 907 can be removed.

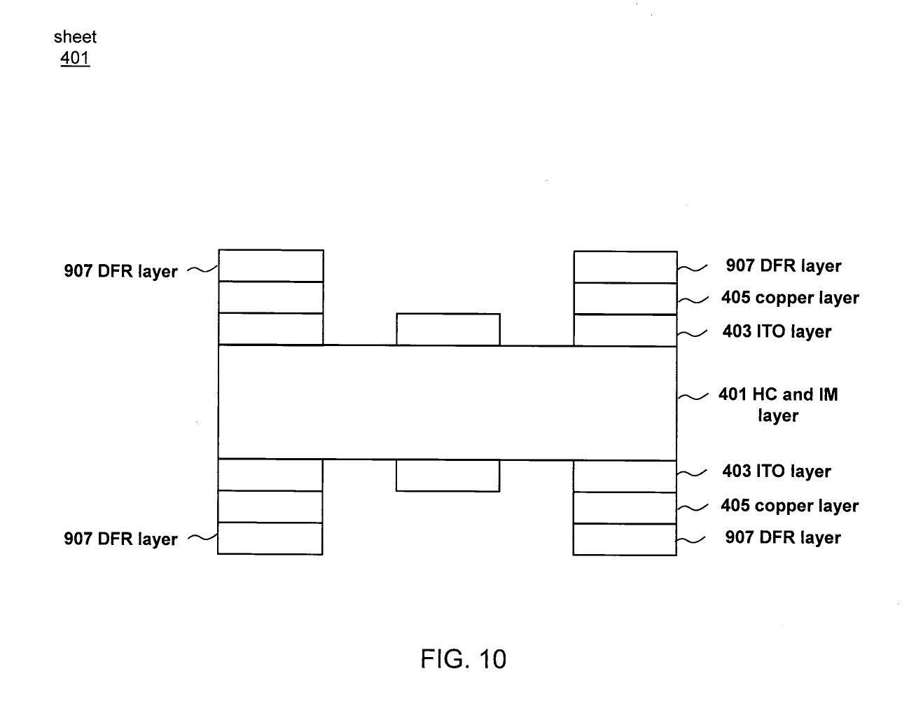

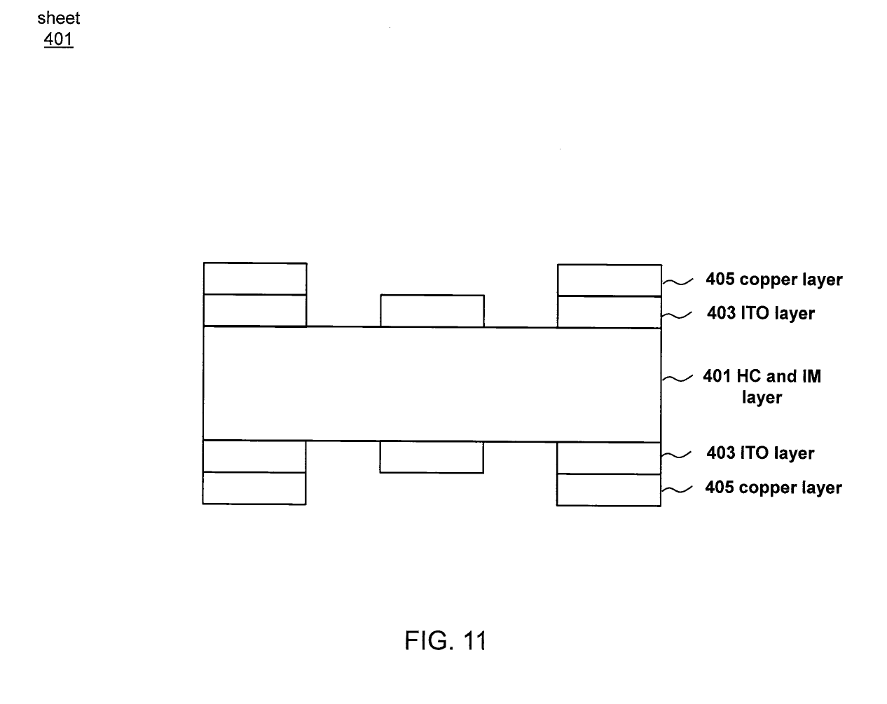

Additionally, at block 311 of process 300, portions of the base film can be etched using the second photoresist layer as a mask. For example, as shown in FIG. 10, the remaining portions of second DFR layer 907 can be used as a mask to selectively etch portions of copper layer 405 within viewable area 201 using an appropriate etchant. After etching away desired portions of the base film, the remaining portions of the second photoresist layer can be stripped away using known techniques. For example, as shown in FIG. 11, the remaining portions of second DFR layer 907 can be removed, leaving behind the patterned ITO and copper layers 403 and 405.

At block 313 of process 300, a third photoresist layer (e.g., a DFR layer) can be laminated onto the sheet of base film. The third photoresist layer can be laminated onto the base film in a manner similar or identical to that performed at blocks 301 and 307 of process 300. In some examples, the third photoresist layer can be laminated over one or both sides of the structure shown in FIG. 11.

At block 315, the third photoresist layer can be exposed using known exposure techniques to form a desired pattern in the photoresist layer. At block 317 of process 300, the third photoresist layer can then be developed to remove portions of the photoresist layer based on the pattern formed in the photoresist layer at block 313. In some examples, the portions of the third photoresist layer removed at block 317 can be located at positions corresponding to a circuit element of the touch sensors, such as bond pads 205 of touch sensor 200, when the third photoresist layer is aligned with the base film containing the touch sensors. Removing these portions of the photoresist layer allows the bond pads to be electrically coupled to circuitry for interpreting touch signals generated by the touch sensor. In other examples, portions of the third photoresist layer along the edge of the photoresist layer can be removed to recess the photoresist layer from the edge of the underlying touch sensors on the base film to prevent damage during a subsequent die cut process.

After developing the third photoresist layer to form a desired pattern, the photoresist DFR layer can be ultraviolet (UV) cured using known techniques. At block 319, the third photoresist layer can be annealed using known techniques to harden the material. Once annealed, the touch sensors can be removed from the base film using a die cutting or laser cutting technique.

While FIGS. 4-11 show the patterning of both sides of the sheet of COP base film 401, it should be appreciated that different components of the touch sensor can be patterned on each side of the sheet of COP base film 401. For example, the drive lines and associated conductive traces can be patterned on the bottom of the sheet of COP base film 401, while the bond pads, sense lines, and associated conductive traces can be patterned on the top of the sheet of COP base film 401. One of ordinary skill in the art can arrange the components of the touch sensor based on its desired application. Moreover, while the bond pads were described above as being formed at the same time as the drive lines, sense lines, and conductive traces in process 300, it should be appreciated that the bond pads can be deposited after formation of the drive lines, sense fines, and conductive traces. For example, the bond pads can be deposited onto the base film between blocks 311 and 313 of process 300 such that they are coupled to conductive traces 203 as shown in FIG. 2. In these examples, the bond pads can be formed using known patterning techniques, such as deposition or photolithography.

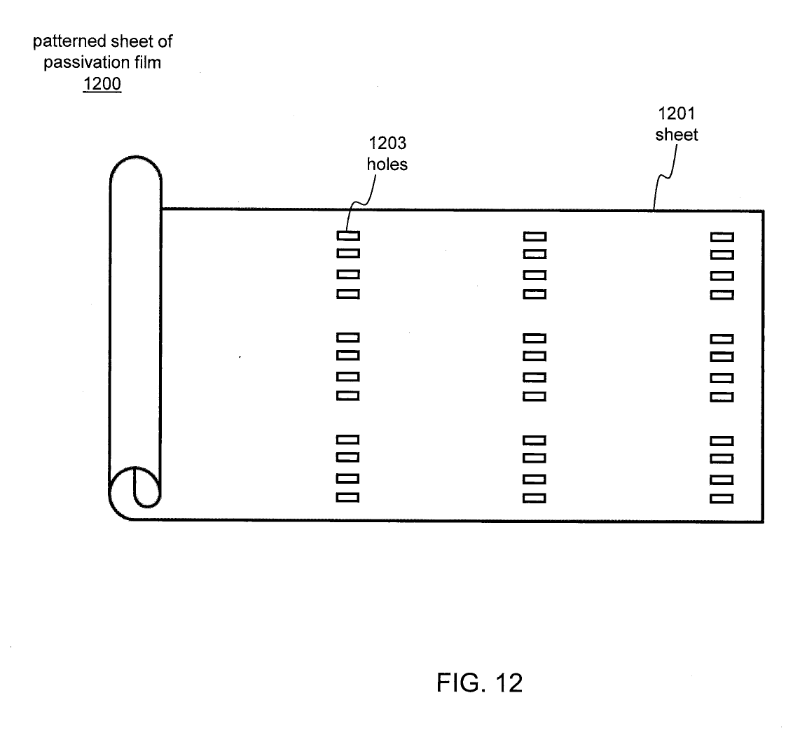

As illustrated by FIGS. 3-11, exemplary roll-to-roll process 300 includes many steps, causing the process to be susceptible to yield loss due to manufacturing defects in the devices. To reduce the chance of device defects, process 300 can be modified by using a patterned sheet of photoresist film, such as that shown in FIG. 12, in place of any of the photoresist layers. The patterned sheet of photoresist film can be cut using known laser cutting or die cutting techniques to form a desired pattern in the film. For example, FIG. 12 shows patterned sheet of photoresist film 1200 having multiple holes 1203 in sheet of photoresist film 1201. Using a sheet of photoresist film that is patterned prior to laminating the photoresist film onto the base film obviates the need for the exposure and development steps that would otherwise be performed after laminating conventional photoresist layers.

For example, to pattern a sheet of photoresist film to be used in place of the first photoresist layer in process 300, portions of the sheet of photoresist film can be cut away using a die cutter or a laser cutter to form the pattern that would otherwise be formed by the exposure and development steps performed at blocks 303 and 305. Thus, when using a patterned sheet of photoresist film in place of the first photoresist layer, process 300 can be modified by laminating the patterned sheet of photoresist film onto the base film at block 301 and skipping the exposure step performed at block 303 and the development step performed at block 305. The remaining steps of the process can remain the same.

Similarly, to pattern a sheet of photoresist film to be used in place of the second photoresist layer in process 300, portions of the sheet of photoresist film can be removed using a die cutter or a laser cutter to form the pattern that would otherwise be formed by the exposure and development steps performed at blocks 309 and 311. Thus, when using a patterned sheet of photoresist film in place of the second photoresist layer, process 300 can be modified by laminating the patterned sheet of photoresist film onto the base film at block 307 and skipping the exposure step performed at block 309 and the development step performed at block 311. The remaining steps of the process can remain the same.

Lastly, to pattern a sheet of photoresist film to be used in place of the third photoresist layer in process 300, portions of the sheet of photoresist film can be removed using a die cutter or a laser cutter to form the pattern that would otherwise be formed by the exposure and development steps performed at blocks 315 and 317. Thus, when using a patterned sheet of photoresist film in place of the third photoresist layer, process 300 can be modified by laminating the patterned sheet of photoresist film onto the base film at block 313 and skipping the exposure step performed at block 315 and the development step performed at block 317. The remaining steps of the process can remain the same.

It should be appreciated that a patterned sheet of photoresist film can be used to replace any combination of the first, second, and third photoresist layers in process 300 and that process 300 can be modified accordingly.

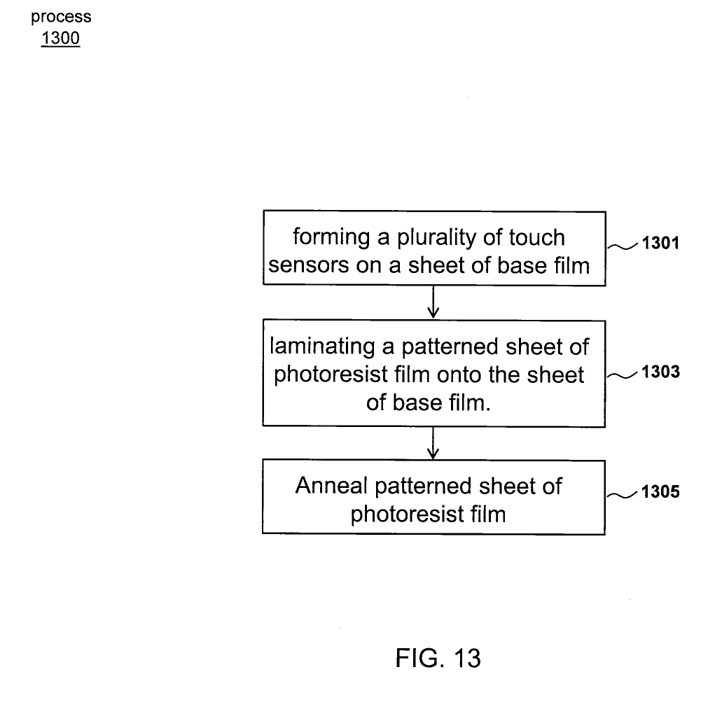

FIG. 13 illustrates an exemplary process 1300 for manufacturing a touch sensor using a patterned sheet of photoresist film, such as patterned sheet of photoresist film 1200, according to various examples. At block 1301, a plurality of touch sensors can be formed on a substrate, such as a sheet of base film. In some examples, the touch sensors can be formed on a base film similar or identical to base film. 401 using blocks 301, 303, 305, 307, 309, and 311 of process 300. In other examples, the drive lines, sense lines, conductive traces, and bond pads can be formed using other known roll-to-roll processing techniques.

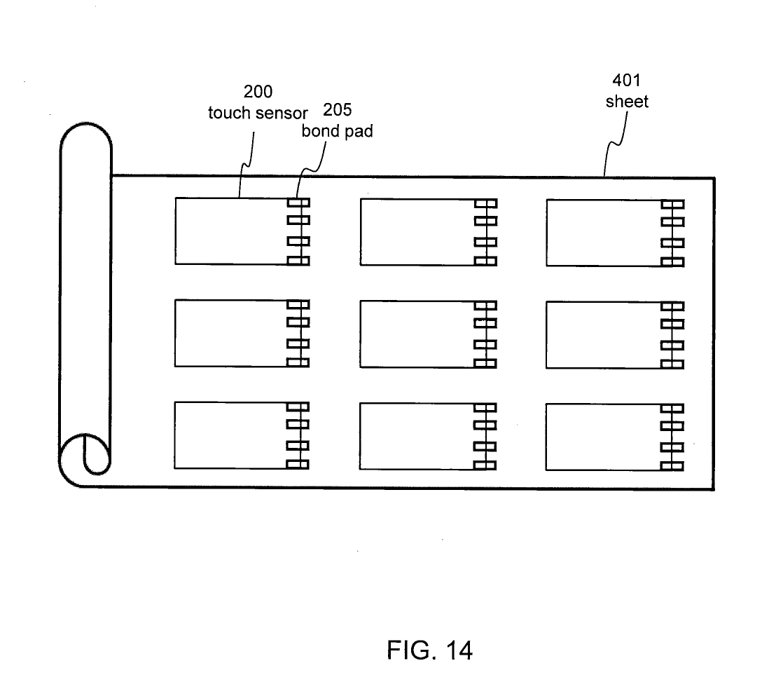

FIG. 14 shows a sheet of base film 401 having multiple touch sensors 200 formed thereon that can be created at block 1301 of process 1300. In the illustrated example, each touch sensor 200 can include one or more bond pads 205. While not shown, it should be appreciated that touch sensors 200 can also include drive lines, sense lines, and conductive traces similar to those shown in FIG. 2.

At block 1303 of process 1300, a patterned sheet of photoresist film can be laminated onto the base film containing the plurality of touch sensors. In some examples, the patterned photoresist film can include a sheet of photoresist film that has been die cut or laser cut to have a desired pattern prior to being laminated onto the base film. For example, the patterned sheet of photoresist film can be cut to have a pattern similar to that shown in FIG. 12. In particular, a patterned sheet of photoresist film 1200 can be formed from a sheet 1201 of photoresist film, such as DFR, that is cut to include multiple holes 1203 at locations corresponding to a circuit element of the touch sensors, such as bond pads 205 of the touch sensors 200, when the patterned sheet of photoresist film 1200 is aligned with base film 401. Thus, at block 1303, patterned sheet of photoresist film 1200 can be laminated onto the sheet of base film 401 shown in FIG. 14 with holes 1203 aligned with the circuit elements (e.g., bond pads 205) such that the circuit elements (e.g., bond pads) are exposed through holes 1203 of patterned sheet of photoresist film 1200.

In some examples, to align holes 1203 of patterned sheet of photoresist film 1200 with the circuit elements (e.g., bond pads 205), an optical alignment system having an optical sensor can be used to detect one or more of the edges of the patterned sheet of photoresist film 1200, edges of holes 1203, edges of sheet of base film 401, and edges of the circuit elements (e.g., bond pads 205). In some examples, based on the measurements from the optical sensor, the rolls used in process 1300 can be adjusted to appropriately align the two sheets,

At block 1305, the patterned sheet of photoresist film can be annealed in a manner similar to that of block 319 of process 300 to harden the material. Once annealed, the touch sensors can be removed from the base film using a die cutting or laser cutting technique.

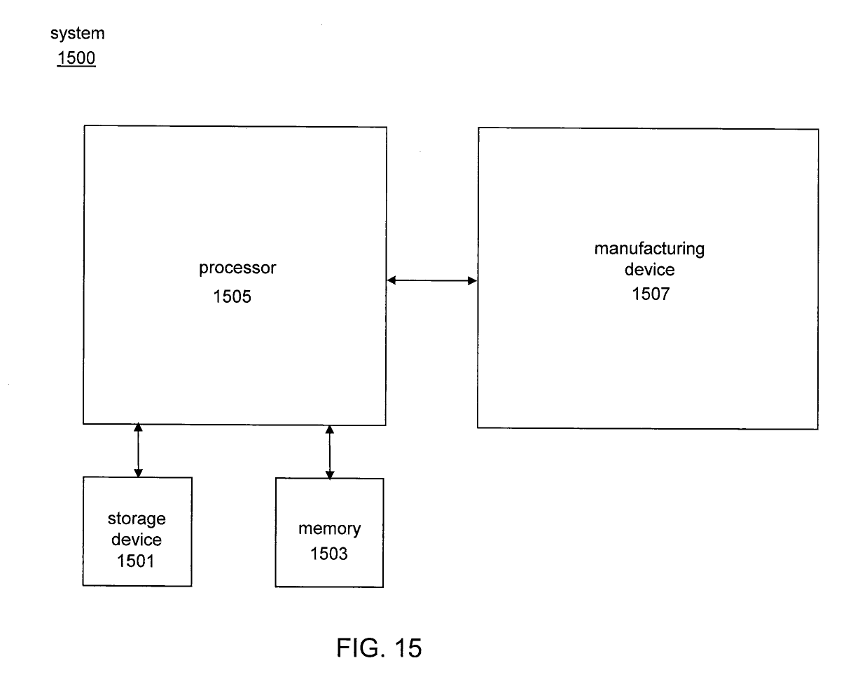

One or more of the functions relating to the manufacturing of a touch sensitive device using a patterned sheet of photoresist film can be performed by a system similar or identical to system 1500 shown in FIG. 15. System 1500 can include instructions stored in a non-transitory computer readable storage medium, such as memory 1503 or storage device 1501, and executed by processor 1505. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

System 1500 can further include manufacturing device 1507 coupled to processor 1505. Manufacturing device 1507 can be operable to form a touch sensor or other electronic device on a base film using a roll-to-roll process, as discussed above with respect to FIGS. 3 and 13. In some examples, manufacturing device 1507 can include an optical sensor to detect edges of the patterned photoresist film, edges of the pattern formed in patterned photoresist film, edges of the sheet of base film, and/or edges of a relevant reference on the sheet of base film (e.g., edges of a bond pad formed on the sheet of base film). Processor 1505 can control manufacturing device 1507 and its components to generate a desired pattern of conductive traces, drive lines, sense lines, and circuit elements of the touch sensor (e.g., bond pads) in a manner similar or identical to that described above with respect to processes 300 and 1300. Additionally, processor 1505 can control manufacturing device 1507 and its components to align a patterned sheet of photoresist film with a sheet of base film on which devices have been manufactured as discussed above with respect to process 1300.

It is to be understood that the system is not limited to the components and configuration of FIG. 15, but can include other or additional components in multiple configurations according to various examples. Additionally, the components of system 1500 can be included within a single device, or can be distributed between two manufacturing device 1507, in some examples, processor 1505 can be located within manufacturing device 1507.

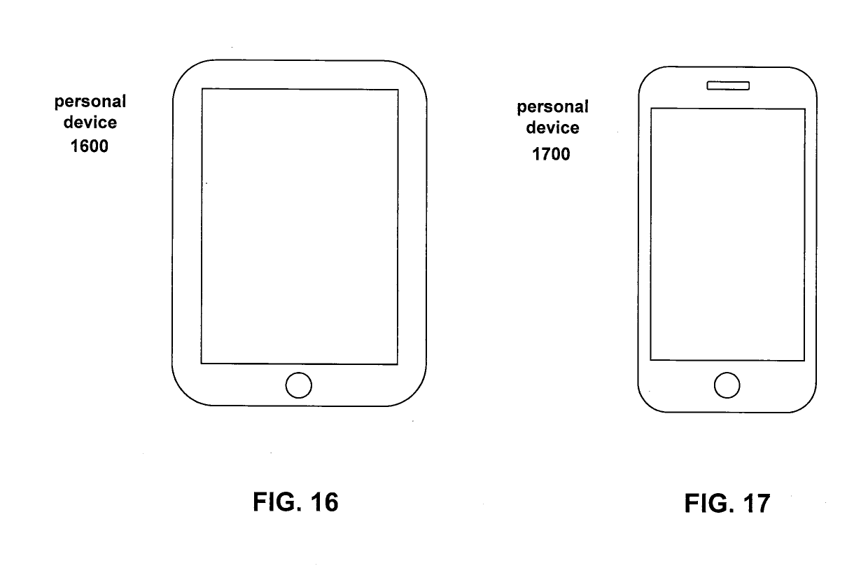

FIG. 16 illustrates an exemplary personal device 1600, such as a tablet, that can include a touch sensor made using a patterned sheet of photoresist film according to various examples.

FIG. 17 illustrates another exemplary personal device 1700, such as a mobile phone, that can include a touch sensor made using a patterned sheet of photoresist film according to various examples.

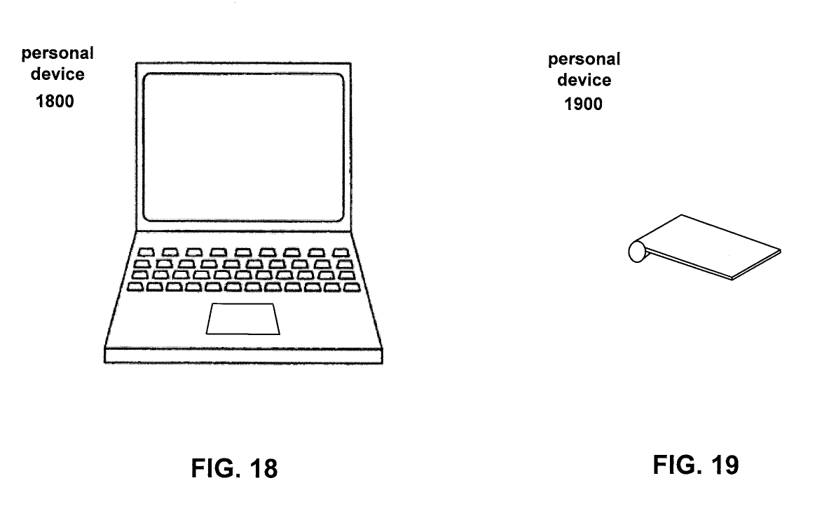

FIG. 18 illustrates an exemplary personal device 1800, such as a laptop having a touchpad, that can include a touch sensor made using a patterned sheet of photoresist film according to various examples.

FIG. 19 illustrates another exemplary personal device 1900, such as a touch pad, that can include a touch sensor made using a patterned sheet of photoresist film according to various examples.

Therefore, according to the above, some examples of the disclosure are directed to a method comprising: forming a plurality of touch sensors on a sheet of base film; and laminating a patterned sheet of photoresist film on the sheet of base film, wherein portions of the patterned sheet of photoresist film have been removed at locations corresponding to one or more circuit elements of the plurality of touch sensors. Additionally or alternatively to one or more of the examples disclosed above, each of the plurality of touch sensors may include a bond pad, wherein the one or more circuit elements of the plurality of touch sensors may include the bond pads. Additionally or alternatively to one or more of the examples disclosed above, laminating the patterned sheet of photoresist film on the sheet of base film may include aligning the portions of the patterned sheet of photoresist film that have been removed with the bond pads of the plurality of touch sensors. Additionally or alternatively to one or more of the examples disclosed above, an optical sensor may be used to align the portions of the patterned sheet of photoresist film that have been removed with the bond pads of the plurality of touch sensors. Additionally or alternatively to one or more of the examples disclosed above, a die cutter or a laser cutter may be used to remove the portions of the patterned sheet of photoresist film. Additionally or alternatively to one or more of the examples disclosed above, the patterned sheet of photoresist film may be patterned prior to laminating. Additionally or alternatively to one or more of the examples disclosed above, forming a plurality of touch sensors may include: laminating a first photoresist layer onto the base film; exposing the first photoresist layer; developing the first photoresist layer; etching the base film using the first photoresist layer as a mask; stripping the first photoresist layer from the base film; laminating a second photoresist layer onto the base film; exposing the second photoresist layer; developing the second photoresist layer; etching the base film using the second photoresist layer as a mask; and stripping the second photoresist layer from the base film.

Therefore, according to the above, some examples of the disclosure are directed to a method comprising: forming a plurality of drive lines on a sheet of base film; forming a plurality of sense lines on the sheet of base film; forming a plurality of bond pads on the sheet of base film; forming a plurality of conductive traces on the sheet of base film that couple together the bond pads with the plurality of sense lines and the plurality of drive lines; and laminating a patterned sheet of photoresist film on the substrate, wherein the patterned sheet of photoresist film was patterned prior to laminating. Additionally or alternatively to one or more of the examples disclosed above, the patterned sheet of photoresist film may be patterned using a die cutter or a laser cutter. Additionally or alternatively to one or more of the examples disclosed above, the method may further include ultraviolet (UV) curing the patterned sheet of photoresist. Additionally or alternatively to one or more of the examples disclosed above, the method may further include annealing the UV cured patterned sheet of photoresist film. Additionally or alternatively to one or more of the examples disclosed above, the base film may include cyclo olefin polymer. Additionally or alternatively to one or more of the examples disclosed above, the patterned sheet of photoresist film may include a plurality of holes at locations corresponding to locations of the plurality of bond pads.

Therefore, according to the above, some examples of the disclosure are directed to a method comprising: forming a plurality of holes in a sheet of photoresist film to form a patterned sheet of photoresist film; and laminating the patterned sheet of photoresist film onto a sheet of base film comprising a plurality of touch sensors. Additionally or alternatively to one or more of the examples disclosed above, the plurality of holes in the sheet of photoresist film may be formed using a die cutter or a laser cutter. Additionally or alternatively to one or more of the examples disclosed above, the plurality of holes in the patterned sheet of photoresist film may be positioned at locations corresponding to bond pads of the plurality of touch sensors. Additionally or alternatively to one or more of the examples disclosed above, the patterned sheet of photoresist film may include a sheet of dry film resist. Additionally or alternatively to one or more of the examples disclosed above, the method may further include UV curing the patterned sheet of photoresist film, wherein the method may exclude an exposure and development step performed on the patterned sheet of photoresist film between laminating and UV curing.

Therefore, according to the above, some examples of the disclosure are directed to a method comprising: removing portions of a sheet of photoresist to form a first patterned sheet of photoresist; laminating the first patterned sheet of photoresist onto a substrate; and etching the substrate using the first patterned sheet of photoresist as a mask. Additionally or alternatively to one or more of the examples disclosed above, wherein removing portions of the sheet of photoresist to form a patterned sheet of photoresist may include using a die cutter or a laser cutter to remove the portions of the sheet of photoresist. Additionally or alternatively to one or more of the examples disclosed above, wherein etching the substrate using the patterned sheet of photo resist as a mask may include etching the substrate to form a plurality of drive lines, a plurality of sense lines, a plurality of bond pads, and a plurality of conductive traces on the substrate. Additionally or alternatively to one or more of the examples disclosed above, the method may further include: stripping the first patterned sheet of photoresist from the substrate: laminating a second patterned sheet of photoresist onto the substrate; UV curing the second patterned sheet of photoresist; and annealing the UV cured second patterned sheet of photoresist. Additionally or alternatively to one or more of the examples disclosed above, portions of the second patterned sheet of photoresist film may have been removed at locations corresponding to the plurality of bond pads. Additionally or alternatively to one or more of the examples disclosed above, the substrate may include a cyclo olefin polymer base film.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the appended claims.

What is claimed is:

1. A method comprising:
forming a plurality of touch sensors on a sheet of base film; and
laminating a patterned sheet of photoresist film on the sheet of base film, wherein portions of the patterned sheet of photoresist film have been removed at locations corresponding to one or more circuit elements of the plurality of touch sensors.

2. The method of claim 1, wherein each of the plurality of touch sensors comprises a bond pad, and wherein the one or more circuit elements of the plurality of touch sensors comprises the bond pads.

3. The method of claim 1, wherein laminating the patterned sheet of photoresist film on the sheet of base film comprises aligning the portions of the patterned sheet of photoresist film that have been removed with the bond pads of the plurality of touch sensors.

4. The method of claim 3, wherein an optical sensor is used to align the portions of the patterned sheet of photoresist film that have been removed with the bond pads of the plurality of touch sensors.

5. The method of claim 1, where a die cutter or a laser cut was used to remove the portions of the patterned sheet of photoresist film.

6. The method of claim 5, wherein the patterned sheet of photoresist film was patterned prior to laminating,

7. The method of claim 1, wherein forming a plurality of touch sensors comprises:
laminating a first photoresist layer onto the base film;
exposing the first photoresist layer;
developing the first photoresist layer;
etching the base film using the first photoresist layer as a mask;
stripping the first photoresist layer from the base film;
laminating a second photoresist layer onto the base film;
exposing the second photoresist layer;
developing the second photoresist layer;
etching the base film using the second photoresist layer as a mask; and
stripping the second photoresist layer from the base film.

8. A method comprising:
forming a plurality of drive lines on a sheet of base film;
forming a plurality of sense lines on the sheet of base film;
forming a plurality of bond pads on the sheet of base film;
forming a plurality of conductive traces on the sheet of base film that couple together the bond pads with the plurality of sense lines and the plurality of drive lines; and
laminating a patterned sheet of photoresist film on the substrate, wherein the patterned sheet of photoresist film was patterned prior to laminating.

9. The method of claim 8, wherein the patterned sheet of photoresist film is patterned using a die cutter or a laser cutter.

10. The method of claim 8 further comprising ultraviolet (UV) curing the patterned sheet of photoresist.

11. The method of claim 10 further comprising annealing the UV cured patterned sheet of photoresist film.

12. The method of claim 8, wherein the base film comprises cyclo olefin polymer.

13. The method of claim 8, wherein the patterned sheet of photoresist film comprises a plurality of holes at locations corresponding to locations of the plurality of bond pads.

14. A method comprising:
forming a plurality of holes in a sheet of photoresist film to form a patterned sheet of photoresist film; and
laminating the patterned sheet of photoresist film onto a sheet of base film comprising a plurality of touch sensors.

15. The method of claim 14, wherein the plurality of holes in the sheet of photoresist film are formed using a die cutter or a laser cutter.

16. The method of claim 14, wherein the plurality of holes in the patterned sheet of photoresist film are positioned at locations corresponding to bond pads of the plurality of touch sensors.

17. The method of claim 14, wherein the patterned sheet of photoresist film comprises a sheet of dry film resist.

18. The method of claim 14 further comprising UV curing the patterned sheet of photoresist film, wherein the method excludes an exposure and development step performed on the patterned sheet of photoresist film between laminating and UV curing.

19. A method comprising:
removing portions of a sheet of photoresist to form a first patterned sheet of photoresist;
laminating the first patterned sheet of photoresist onto a substrate; and
etching the substrate using the first patterned sheet of photoresist as a mask.

20. The method of claim 19, wherein removing portions of the sheet of photoresist to form a patterned sheet of photoresist comprises using a die cutter or a laser cutter to remove the portions of the sheet of photoresist.

21. The method of claim 19, wherein etching the substrate using the patterned sheet of photo resist as a mask comprises etching the substrate to form a plurality of drive lines, a plurality of sense lines, a plurality of bond pads, and a plurality of conductive traces on the substrate.

22. The method of claim 21 further comprising:
stripping the first patterned sheet of photoresist from the substrate;
laminating a second patterned sheet of photoresist onto the substrate;
UV curing the second patterned sheet of photoresist; and
annealing the UV cured second patterned sheet of photoresist.

23. The method of claim 22, wherein portions of the second patterned sheet of photoresist film have been removed at locations corresponding to the plurality of bond pads.

24. The method of claim 1.9, wherein the substrate comprises a cyclo olefin polymer base film.
